(19) United States
(12) Patent Application Publication
(10) Pub. No.: US 2011/0116542 A1
(43) Pub. Date: May 19, 2011

(54) SYMBOL PLANE ENCODING/DECODING WITH DYNAMIC CALCULATION OF PROBABILITY TABLES

(75) Inventors: Marie Oger, Nevilly Sur Seine (FR); Thi Minh Nguyet Hoang, Lannion (FR); Stephane Ragot, Lannion (FR); Marc Antonini, Nice (FR)

(73) Assignee: France Telecom, Paris (FR)

(21) Appl. No.: 12/674,885

(22) PCT Filed: Jul. 25, 2008
(86) PCT No.: PCT/FR2008/051412

§ 371 Date: Dec. 22, 2010

(30) Foreign Application Priority Data
Aug. 24, 2007 (FR) 0706001

(51) Int. Cl. H04B 1/66

(52) U.S. Cl. 375/240.03; 375/240.02; 375/E07.126

(57) ABSTRACT

The invention relates to an arithmetic encoding by bit planes (MSB, . . . , LSB), that comprises using tables of probability to have a 0 or 1 bit for encoding each bit plane. According to an embodiment of the invention, the probability tables are calculated dynamically for each signal frame based on a probability density model (Mod) corresponding to the distribution (H) of the signal (X) on each frame.

This application is a 35 U.S.C. §371 National Stage entry of International Application No. PCT/FR2008/051412, filed on Jul. 25, 2008, and claims priority to French Application No. FR 0706001, filed on Aug. 24, 2007 each of which is hereby incorporated by reference in its entirety for all purposes as if fully set forth herein.

### FIELD OF THE INVENTION

The invention relates to encoding/decoding of digital signals such as speech signals, image signals, or more generally audio and/or video signals, or even more generally multimedia signals, for their storage and/or their transmission.

### BACKGROUND OF THE INVENTION

Among the fundamental compression methods for digital signals, we differentiate between lossless compression methods (Huffman coding, Golomb-Rice coding, arithmetic encoding), also called “entropy coding”, and lossy compression methods based on scalar or vector quantization.

With reference to FIG. 1, a general compression encoder typically comprises:

an analysis module 100 for analyzing the source to be encoded S,

a quantization module 101 (scalar or vector), followed by

an encoding module 102

while an equivalent decoder comprises:

a decoding module 103,

an inverse quantization module 104, and

a synthesis module 105.

In the following description, the analysis and synthesis are not discussed. Only the quantization followed by the associated encoding and/or decoding is considered. We are more interested here in the scalar quantization of a block of data followed by an encoding of quantization indices using symbol planes. This encoding technique, used in several signal compression standards (encoding MPEG-4 audio in the “Bit Sliced Arithmetic encoding” (BSAC) encoder, encoding JBIG images in bit planes of an image, encoding in particular using the JPEG2000 standard, encoding MPEG-4 video) is diagrammed in FIG. 2.

With reference to FIG. 2, in scalar quantization followed by symbol plane encoding, the encoding typically involves:
a module 200 to adapt the source signal S to deliver a vector denoted by X=[x₁ . . . x_{N}] of dimension N≧1,
a scalar quantization module 201 delivering a quantized vector defining a sequence of integer values Y=[y₁ . . , y_{N}],
a symbol plane decomposition module 202 where the symbols can be bits at 0 or 1, with this module 202 then delivering a vector of values Pₖ=[a_{1,k} . . . a_{N,k}] where k=0, . . . , K−1, and a vector of signs S=[s₁ . . . s_{N}],
a module 203 for encoding the bit plane and multiplexing the encoded values, and
a module 204 for regulating the bit rate according to the number of bits Nb to use for the transmission;
   and the decoding involves:
a demultiplexing and decoding module 206,
and a module 207 for conversion into integers in order to deliver a vector \tilde{Y} such that \tilde{Y}=Y, in the absence of bit errors and without truncating the bit stream.

Thus, from the adapted signal to be encoded, X=[x₁ . . . x_{N}], the scalar quantization (performed by the module 201) produces a sequence of integer values Y=[y₁ . . . y_{N}]. The decomposition into bit planes (performed by the module 202) first involves separating signs and absolute values, as follows:

$${y}_{i} = {( - 1 )}^{{s}_{i}} \times {a}_{i} , with {a}_{i} = \vert {y}_{i} \vert \text{\&} {s}_{i} = \{ \begin{matrix}1 & if {y}_{i} < 0 \\ 0 & if {y}_{i} \geq 0\end{matrix}$$

then decomposition of the absolute values into bit form, with:

aᵢ=B_{K-1}(aᵢ)2^{K-1}+ . . . Bₖ(a₁)2^{k}+ . . . +B₁(aᵢ)2¹+Bₙ(a₁)2ⁿ, where
Bₖ(aᵢ) is the k^{th} bit of the binary decomposition of the absolute value aᵢ of the quantized component Yᵢ and
K is the total number of bit planes for the decomposition of the set of values aᵢ, with this number K being defined by:

$$K = max ( ⌈ {log}_{2} ( {max}_{i = 1 , … , n} {a}_{i} ) ⌉ , 1 )$$

where [.] designates rounding up to the higher integer and where log₂(0)=−∞. One will note that as the sign of the zero value is undefined, the above convention (sᵢ=0 for yᵢ=0) can be changed (to sᵢ=1 for yᵢ=0).

The entropy coding of the planes (module 203) can advantageously be done by an encoder called a “context-based arithmetic” encoder.

The principle of an arithmetic encoder is explained in the Witten et al document: “Arithmetic encoding for Data Compression”, I. H. Witten, R. M. Neal, J. G. Cleary, Communications of the ACM—Computing Practices, Vol. 30, No. 6 (June 1987), pp. 520-540.

One will see, for example with reference to table I (page 521) of this Witten et al document, that the probability tables must be defined beforehand in order to perform the encoding. In a “context-based” arithmetic encoder, the data taken from probability tables for the symbols 0 and 1 are not always the same and can evolve as a function of a context which can depend, for example, on the values of neighboring bits already decoded (for example in the higher bit planes and in the adjacent elements). The principle of a context-based arithmetic encoder is described in particular in the Howard et al document: “Arithmetic encoding for Data Compression”, P. G. Howard and J. S. Vitter, Proc. IEEE, vol. 82, no. 6 (June 1994).

In general, the module 203 encodes the bit planes one by one, starting with the most significant bit planes and continuing to the least significant bit planes. This concept of more or less significant bit planes will be described below with reference to FIG. 3. The bits of sign sᵢ, where i=1, . . . , n, are only sent if the corresponding absolute value aᵢ is non-zero. To allow partial decoding of bit planes, the sign bit sᵢ is sent as soon as one of the decoded bits [a_{i,k}]k=0. . . . ,K−1 is equal to 1.

The bit rate output from the encoder is generally variable. In the following description, the manner of managing this variable bit rate is not described (modules 200 and 204 in FIG. 2). The bit stream generated by the module 203 is then sent over a channel 205, which can truncate the bit stream (by exploiting the hierarchical nature of the bit stream) or introduce bit errors.

At decoding, the demultiplexer-decoder (module 206) reconstructs the bit planes \tilde{P}ₖ, one by one, and decodes the sign bits \tilde{s} which were sent. This decoded information allows reconstructing (module 207) the signal Y. If there are no bit errors and no bit stream truncation, we of course have:

\tilde{P}ₖ=Pₖ, \tilde{S}=S and therefore \tilde{Y}=Y

For clarity, it is assumed in the rest of this document that there are no bit errors.

The primary interest of bit plane encoding is that it leads naturally to a hierarchical (or progressive) encoding of the signal. Successive and increasingly precise approximations of the signal can be reconstructed as the bit stream sent by the encoder is received.

An example of bit plane decomposition is given in FIG. 3 for N=8. In the example represented, the vector Y is such that Y=[−2,+7,+3,0,+1,−3,−6,+5]. The non-zero values {yᵢ}i=2, . . . , N are said to be “significant” (denoted VS in FIG. 3). The sign bits are represented by the vector denoted by sgn in FIG. 3. In this case, we have K=3, P₀=[0,1,1,0,1,1,0,1], P₁=[1,1,1,0,0,1,1,0], P₂=[0,1,0,0,0,0,1,1] and S=[1,0,0,0,0,1,1,0].

The vector Pₖ then represents a bit plane of weight k. The highest bit plane P_{K-1} represents the most significant bit plane (denoted by MSB for “Most Significant Bits”) while the lowest bit plane P₀ represents the least significant bit plane (denoted by LSB for “Least Significant Bits”).

The operation of the module 203 in FIG. 2 is now described in more detail, with reference to FIG. 4 corresponding to a flow chart of arithmetic encoding by bit planes (following a scalar quantization). This involves encoding with N-dimensional multiplexing as known in the art. After a starting step 400, the total number K of bit planes is obtained (step 401). A current loop index k is decremented and the value of this current index is therefore initially set to k=K−1 (step 402) so that the processing ends when k=0. The test 403 verifies that the value of k=0 has not yet been reached. As long as this value k=0 has not been reached (Y arrow), the plane Pₖ of current index k is encoded (step 404). The first loop in which k=K−1 therefore processes the plane P_{K-1} corresponding to the MSB plane and the last loop in which k=0 processes the plane P₀ corresponding to the LSB plane. In the step 405, the signs of new significant coefficients associated with the plane Pₖ are sent. The next step 406 decrements the value of the current index k. If the plane P₀ for the value of k=0 has been processed (N arrow exiting the test 403), the processing is ended (end step 407) or restarts with a new block of data from the signal (or frame).

The encoding is therefore done on successive bit planes Pₖ, from the MSB plane to the LSB plane. In addition, it is possible to subdivide the planes Pₖ into subvectors to allow an even more progressive decoding, with this subdivision possibly continuing all the way to subvectors of a single unit in size (equal to 1).

One can then encode bit planes of absolute values by adaptive arithmetic encoding. In fact, the planes Pₖ can be encoded one by one (independently of each other, in a sequential manner from the MSB plane to the LSB plane), by adaptive arithmetic encoding. The adaptation of the probabilities of symbols (0 and 1) in the encoding of a plane Pₖ only uses the bits which were already encoded in the same plane Pₖ. The adaptive arithmetic encoder is therefore reinitialized when the encoding of a new plane Pₖ begins, in particular by initializing the probabilities of 0 and 1 to a value of ½(=0.5) and, as encoding proceeds for the same plane, these probabilities evolve and are adapted by updating the frequency of 0 and 1. A detailed description of this type of encoding is given in the document: “An introduction to arithmetic coding”, G. C. Langdon, IBM J. Res. Dev. 28, 2, p. 135-149 (March 1984).

More sophisticated encoders do not set the initial frequency of 0 and 1 to ½, but store probability values in previously saved tables which give an initial frequency for 0 and 1 adapted to a certain operating context (for example adapted to the bit rate, or to the type of source to be encoded). At best, encoders of the known art therefore require storage of symbol probability tables (containing predefined frequency values). More generally, previously saved tables are usually necessary in order to apply an entropy encoding such as Huffman or arithmetic encoding. The techniques of the known art are therefore not very flexible because they require pre-calculating and storing information which must be adapted to particular operating conditions (bit rate, type of source). As a result, one needs to anticipate all possible situations when designing the encoders/decoders, in order to generate such tables.

The invention aims to improve the situation.

### SUMMARY OF THE INVENTION

For this purpose, there is provided a method for processing a signal for symbol plane compression encoding/decoding of the signal, in which probabilities of symbol values are determined for at least one plane.

In the sense of the invention, these probabilities are calculated dynamically, from an estimate of a signal distribution.

Preferably, as the signal is quantized before encoding, the estimate of the signal distribution is performed on the signal to be encoded, before quantization, in order to have the most accurate estimate possible of the signal distribution (and not an estimate of the distribution of the processed signal after quantization).

In a first embodiment, as the signal comprises a succession of values, each value is decomposed into a plurality of symbol values in a respective plurality of symbol planes. The probabilities are calculated for at least one plane and each relates to the probability of having, in this plane, a symbol value equal to a given symbol. Preferably, the probabilities are calculated at least for the plane representing the most significant symbol values.

In a second embodiment, the probabilities are additionally calculated for other planes, taking into account a context defined by symbol values taken from planes representing more significant symbol values.

More particularly, for a same signal value position in said succession of values, each symbol value taken from a plane representing a more significant symbol value than a symbol value in a current plane, defines a context value for this current plane and for this position. The probabilities mentioned above are then calculated for this current plane while taking into account a plurality of possible context values for this current plane.

In a third embodiment, a limited number of possible context values are chosen, preferably two, which are:
a first context value indicating the occurrence of at least one significant symbol value in the planes representing the more significant symbol values,
a second context value signifying that no occurrence of a significant symbol value was found in the planes representing the more significant symbol values.

Unlike the prior art, embodiments of the invention thus propose doing without any storage of probability tables which are instead calculated “on line” (as a function of the signal), and using an estimate of the probability density of the source to be encoded/decoded (for example represented by a generalized Gaussian model) to calculate dynamically the symbol probabilities by plane (for example the probabilities of 0 and 1 for a bit plane). Embodiments of the invention can therefore use the knowledge of a probability model of the source to be encoded (or decoded), and do so for initially estimating the probabilities of symbols in each plane Pₖ.

One can, in effect, “use” a model of the source to be encoded because certain encoders/decoders already implement such modeling, notably for calculating the form factor (conventionally denoted by a) of the signal to be encoded. One can then rely on a preexisting signal distribution model, for example for calculating the form factor α in a transform coder using stack-run coding as presented in the document by Oger et al: “Transform audio coding with arithmetic-coded scalar quantization and model-based bit allocation”, M. Oger, S. Ragot and M. Antonini, ICASSP, April 2007. One should note, however, that said document does not disclose any form of symbol plane encoding.

### BRIEF DESCRIPTION OF THE DRAWINGS

Other features and advantages of the invention will become apparent upon examining the detailed description below and the attached drawings, in which, in addition to FIGS. 1 to 4 described above:

FIG. 5 shows an example of an encoder using, in the sense of embodiments of the invention, a distribution model of the signal to be encoded, for a bit plane encoding,

FIG. 6 shows a decoder that is the counterpart to the encoder in FIG. 5,

FIG. 7 illustrates the probability density of a generalized Gaussian distribution and shows different intervals for calculating the probability p(aᵢ),

FIG. 8 shows the flow chart of bit plane encoding with an initialization of probability tables for each plane Pₖ, according to the first embodiment mentioned above,

FIG. 9 shows the flow chart of a decoding that is the counterpart to the encoding in FIG. 8,

FIG. 10 shows an example of decomposition into three bit planes and context-based encoding for the LSB plane,

FIG. 11 illustrates the bit planes associated with a highly harmonic signal, as well as a histogram H for this signal, for comparison with a distribution model Mod which can be assigned to it (dotted curve),

FIG. 12 illustrates the principle of arithmetic encoding (context-based for encoding the plane P_{K-2} in the example represented) of bit planes whose probability tables were calculated dynamically by a method according to embodiments of the invention,

FIG. 13 shows the flow chart for bit plane encoding with a context-based initialization of probability tables, according to the second embodiment mentioned above, and

FIG. 14 presents the flow chart for bit plane encoding with a context-based initialization of probability tables in the case where only two possible contexts are given, according to the third embodiment mentioned above.

### DETAILED DESCRIPTION OF EMBODIMENTS OF THE INVENTION

Embodiments of the invention propose an symbol plane encoding/decoding, making use of a probability distribution of the source to be encoded in order to estimate the initial probability of symbols (for example 0 and 1) for each plane. This processing aims to optimize the entropy coding by providing dynamic knowledge from probability tables.

We can consider the case of context-based arithmetic encoding such as entropy coding. An example is described below in which the encoding in the sense of the invention is done without the loss of indexes issuing from the quantization of transform coefficients of frequency-domain encoders, in particular for speech signals and/or audio signals. However, the invention equally applies to lossy encoding, in particular signals such as image or video signals.

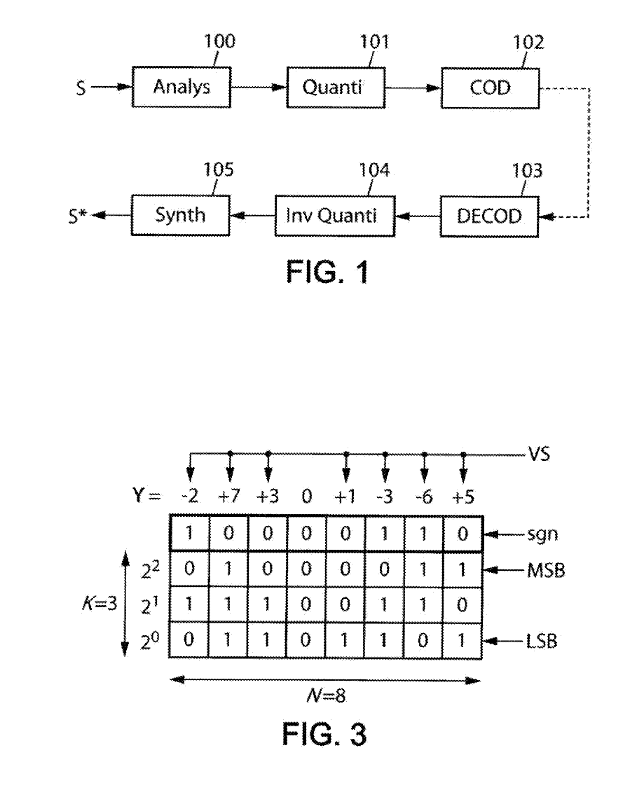

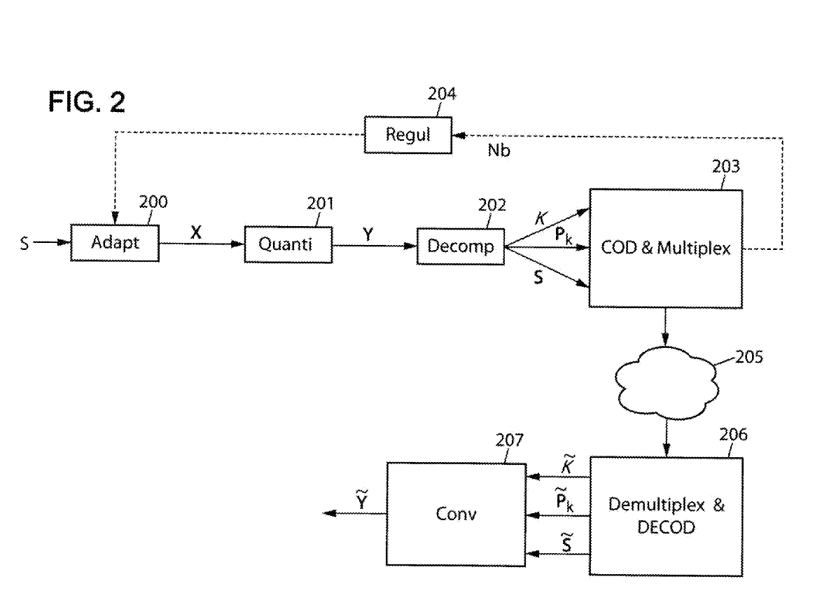

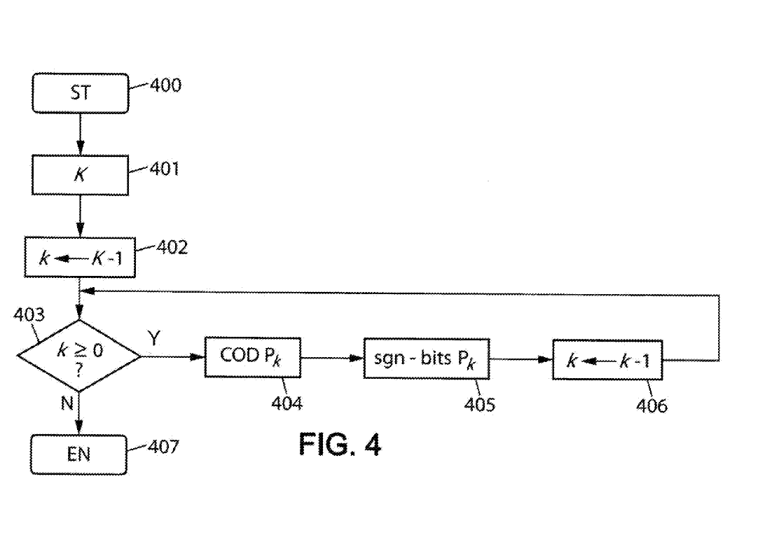

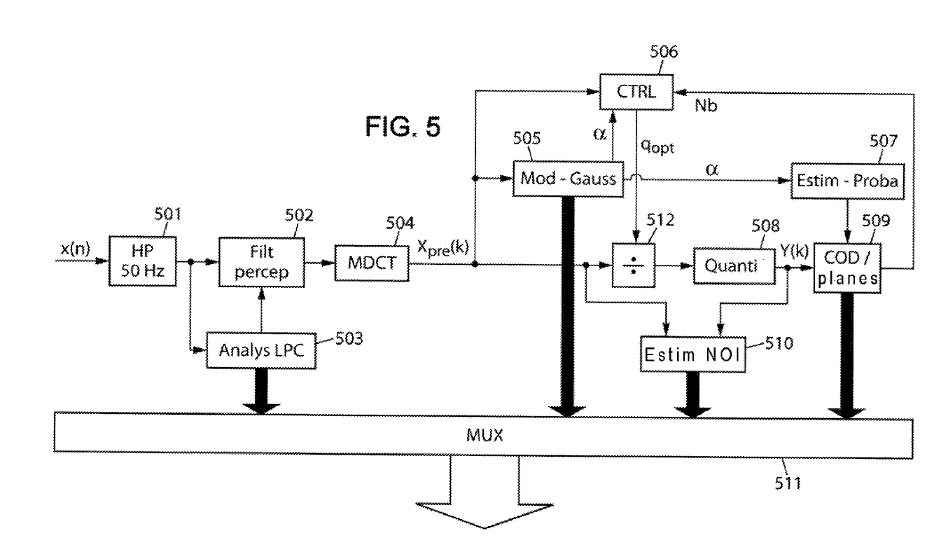

FIG. 5 illustrates an example of an encoder using a distribution model of the signal to be encoded to find the initial probabilities of the symbols 0 or 1 by bit plane, in the sense of the invention. The structure of the encoder, as represented in the example in FIG. 5, is very close to a prior art encoder described in the Oger et al document: “Transform audio coding with arithmetic-coded scalar quantization and model-based bit allocation”, M. Oger, S. Ragot and M. Antonini, ICASSP, April 2007. In particular, the encoder described in this document determines a distribution model for the signal in order to estimate a form factor α which only serves, in the cited document, for controlling the bit rate. This type of encoder uses a stack-run encoding technique and has no relation to a bit plane encoding in the sense of the invention.

Even so, the invention can advantageously benefit from a preexisting structure comprising a form factor calculation module 505 (FIG. 5) and can additionally use this module 505 to perform a bit plane encoding as described below.

With reference to FIG. 5, the encoder in the example represented comprises:
a high-pass filter 501,
a perception-based filtering module 502,
a module 503l for LPC (for “Linear Prediction Coding”) analysis and quantization, in order to obtain short term prediction parameters,
a module 504 for MDCT (for “Modified Discrete Cosine Transform”) and frequency shaping
the module 505 for calculating a form factor α, from a generalized Gaussian model in the example described,
a bit rate control module 506, particularly one which performs such control as a function of the number of bits used Nb,
a module 507 which makes use of the module 505 for performing the calculations serving at least to initialize the probability tables of the bit plane encoding module 509 in a first embodiment, and in context calculations in other later embodiments,
a uniform scalar quantization module 508,
the bit plane encoding module 509
a module 510 for estimating the noise level and quantization,
a multiplexer 511 for multiplexing the outputs from modules 503, 505, 509, and 510, for storage of the encoded data or for transmission for later decoding.

The input signal x(n) is filtered by high-pass filtering (501) in order to remove frequencies below 50 Hz. Then a perception-based filtering is applied to the signal (502) and in parallel an LPC analysis is applied to the signal (503) filtered by the module 501. An MDCT analysis (504) is applied to the signal after perception-based filtering. The analysis used can, for example, be the same as that of the 3GPP standard AMR-WB+ encoder. The form factor α is estimated on the MDCT transform (505) coefficients. In particular, once the form factor is estimated, the quantization step size q appropriate for reaching the desired bit rate (506) is calculated. Then a uniform scalar quantization of the signal is performed using this quantization step size (507), with the module 512 in FIG. 5 dividing by this step size. In this manner a sequence of integers Y(k) is collected which are then encoded by the module 509. Preferably an estimate of the noise to be injected into the decoder (module 510) is also made.

In the example represented in FIG. 5, the encoding is done by transform with bit plane encoding in which the probability tables are initialized in real time, in the sense of the invention, following a dynamically estimated distribution model as a function of the signal to be encoded. The first part of the encoding before the MDCT transform (modules 501 to 504) is equivalent to the stack-run based method used for transform coding as presented in the Oger et al document mentioned above. The form factor estimate (module 505) as well as the bit rate control can also be the same. However, here the information from the module will also be used to estimate the tables (module 507) for the probabilities of the symbols 0 and 1 which will be used at initialization of the encoding module 509. Then a uniform scalar quantization is applied (module 508), with a division module denoted by the reference 512. The quantization can also be the same as that described in the Oger et al document, but here it is followed by a bit plane encoding (module 509) in which the initialization of the probability tables is done, as indicated above, according to a model (defined by the module 505). An estimate of the noise level is made (module 510) which can again be the same as the one in the Oger et al reference. The parameters of the encoder are then sent to the decoder, passing through a multiplexer 511.

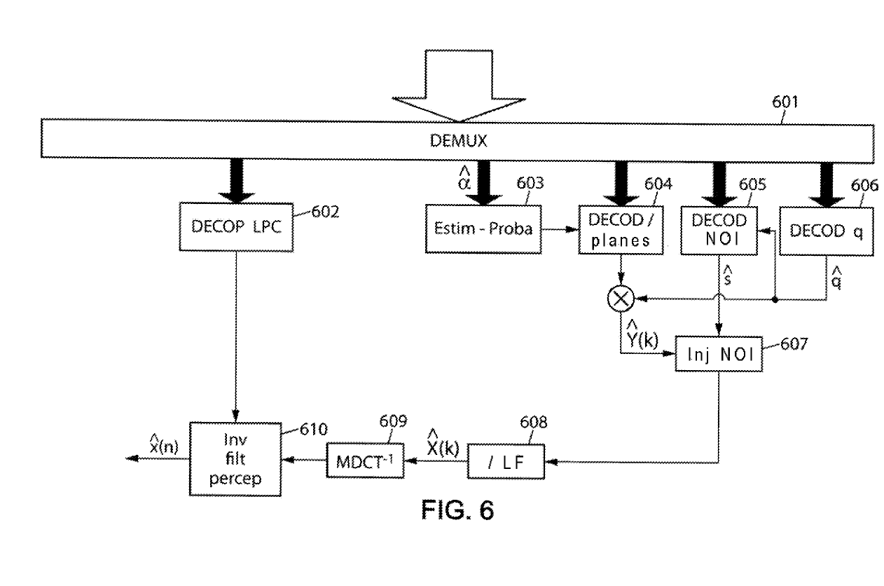

With reference to FIG. 6, a counterpart decoder can comprise:
a module 601 to demultiplex the bit stream received from the encoder in FIG. 5,
a module for decoding LPC coefficients 602,
a module 603 for estimating probabilities based on the model â defined by the module 505 in FIG. 5,
a module 606 for decoding the quantization step size \hat{q},
a module 605 for decoding the noise level ŝ, using the decoded value of the quantization step size,
a bit plane decoding module 604 receiving the estimated probabilities (module 603) in order to deliver, using the decoded value of the quantization step size, the decoded vector of integers Ŷ(k),
a noise injection module 607,
a module 608 for de-emphasis of low frequencies in order to find the decoded vector \hat{X}(k), expressed in the transform domain,
an inverse MDCT transform module 609, and
an inverse perception-based filtering module 610 based on decoded LPC coefficients (module 602), for finding a signal \hat{x}(n) which, without loss or truncation in the communication, corresponds to the original signal x(n) of FIG. 5.

Again with reference to FIG. 5, the number of bits Nb used by the encoding is sent to the bit allocation module for modifying (or adapting) the value of the quantization step size, such that this number of bits remains less than or equal to the available bit budget. The encoding of the MDCT spectrum is therefore done in a bit rate control loop with typically 10 to 20 iterations, in order to reach an optimal quantization step size qₒₚₜ. More particularly, the initial quantization step size, its value for the first iteration based on the determination of the optimal quantization step size qₒₚₜ, is estimated from the form factor α delivered by the module 505 for determining a generalized Gaussian model.

The operation of this module 505 is described in more detail below.

Unlike conventional encoding, this “model based” (probabilistic) encoding consists of quantifying and encoding the source based on a probability model, not directly.

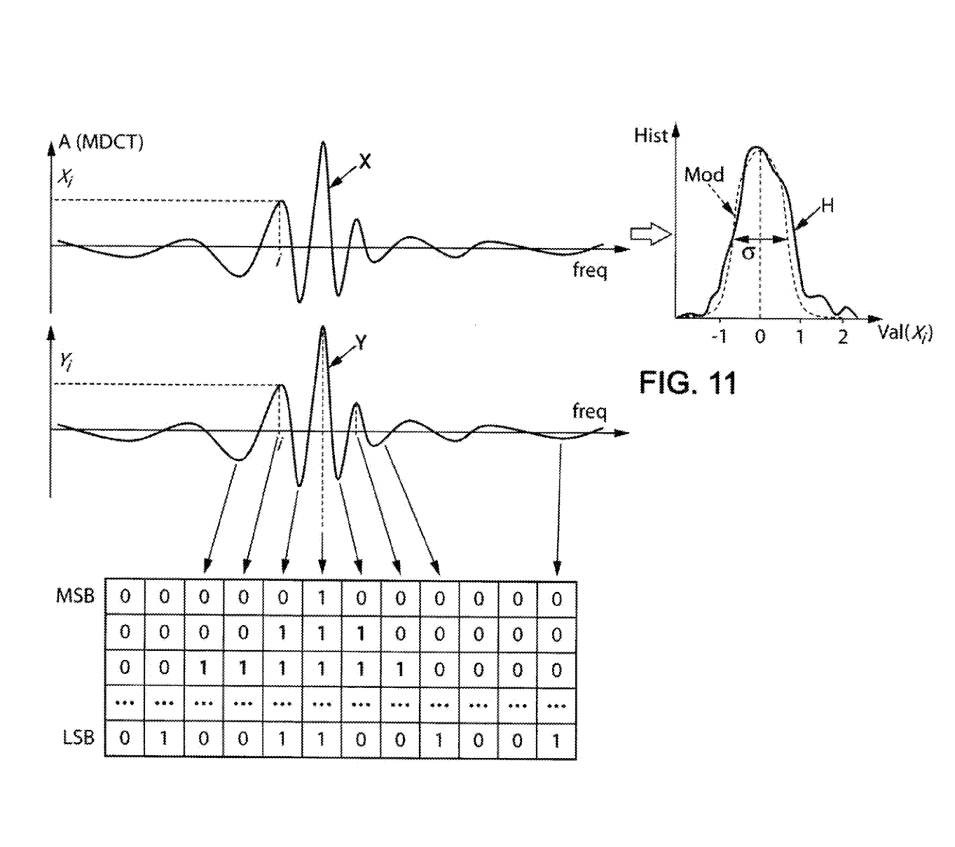

With reference to FIG. 11, the variation in the amplitude (A(MDCT)) is represented for a signal to be quantized and encoded (denoted by X and therefore corresponding to a set of components x,). This signal X can for example be delivered by the module 504 of FIG. 5 and then corresponds to a MDCT signal which is a function of the frequency (freq). One will remember that the signal X is intended to be quantized by a quantization step size q, in order to obtain (as output from the module 508 of FIG. 5) the signal denoted by Y and corresponding to a sequence of components yᵢ. The signs and absolute values aᵢ of these components yᵢ are determined and these absolute values aᵢ are decomposed into MSB . . . LSB bit planes represented in FIG. 11.

More particularly, to obtain the histogram H corresponding to the distribution of the signal X (graph on the right in FIG. 11):
all occurrences where the components x, of the signal X are equal to 0 are “counted” and the number obtained is shown on the y axis (Hist) of the graph, at an x axis value of 0,
then all occurrences where they are equal to 1 are counted and the number obtained is shown on the y axis at an x axis value of 1,
   and so on for the subsequent values 2, 3, etc., and −1, -2, -3, etc. As a result, the reference Val(xᵢ) in FIG. 11 (x axis of the graph on the right) designates all possible values that the signal X can assume.

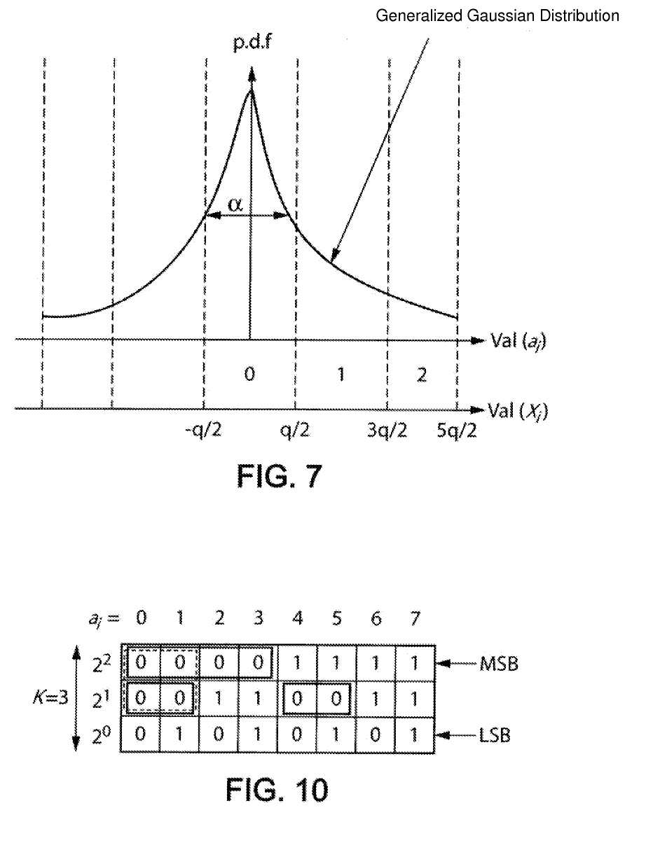

Next, this histogram H is modeled by the model Mod (dotted line) which can, for example, be Gaussian in form. Now with reference to FIG. 7, the distribution H of the signal X can finally be represented by a probability density model (designated pdf for “probability density function”), after a simple change in scale of the x axis values (from Val (xᵢ) to Val (aᵢ), with the reference Val(aᵢ) denoting the various possible values that each absolute value of component aᵢ can assume).

FIG. 7 illustrates an exemplary generalized Gaussian probability density, which is a particular model that can advantageously be chosen. We give it the mathematical expression below (denoted by fₐ).

The probably density of a generalized Gaussian source z, of zero mean and σ standard deviation, is defined by:

$${f}_{α} ( z ) = \frac{A ( α )}{σ} {e}^{- {\vert B ( α ) \frac{z}{σ} \vert}^{α}}$$

where α is the form factor describing the form of the exponential function (FIG. 7), with the parameters A(α) and B(α) being defined by:

$$A ( α ) = \frac{α B ( α )}{2 Γ ( 1 / α )} and B ( α ) = \sqrt{\frac{Γ ( 3 / α )}{Γ ( 1 / α )}}$$

where Γ is the Gamma function defined as follows:)

Γ(α)=∫₀^{∞}e^{-t}t^{α+1}dt

Thus, the source (the signal to be encoded) is modeled as the result of a random selection of a generalized Gaussian variable. This generalized Gaussian model can then advantageously be used to model the spectrum to be encoded in the modified discrete cosine transform (MDCT) domain. One can draw from this model the value of the form factor α which characterizes the model. Remember that advantageously, the form factor α is already estimated for each signal block (or frame) based on the spectrum to be encoded, in certain existing encoders which integrate a module such as the module 505 in FIG. 5, for calculating the quantization step size q.

In the sense of the invention, the estimation of the distribution model (which can lead in particular to the form factor α), also allows calculating the probabilities of symbol values by plane. This technique is described below.

Again with reference to FIG. 7, the estimation of a probability p(aᵢ) of having a component value aᵢ among N possible values (denoted by Val(aᵢ) in FIG. 7) is based on the following calculation:

p(aᵢ)=∫_{qa}_{₁}_{-q/2}^{qa}_{ₐ}_{+q/2}fₐ(y)dy

FIG. 7 also illustrates the different intervals for calculating the probability p(aᵢ). It can already be seen that, as the generalized Gaussian distribution is symmetrical, we have p(aᵢ)=p(−aᵢ). Also note that the intervals are regular because a uniform scalar quantization of step size q is used (to obtain the components yᵢ (or aᵢ) from the components xᵢ). Also note that the higher the maximum value of the components aᵢ, the lower the associated probability p(aᵢ).

The calculation of probabilities p(aᵢ) can be done by conventional integration methods. In a preferred embodiment the “trapezoidal” method is used, which is simple to apply. Preferably the value of the standard deviation α is normalized to 1 such that the quantization step size, for calculating the integral in the above equation, becomes q/σ. This operation allows more effective calculation of integrals, because the problem of variation of signal dynamics is thus eliminated and we are returned to a central source of unit variance no matter what the value of the form factor.

Three embodiments are presented below for estimating the probabilities of the symbols 0 and 1 by bit planes, based on these calculations of probabilities p(aᵢ).

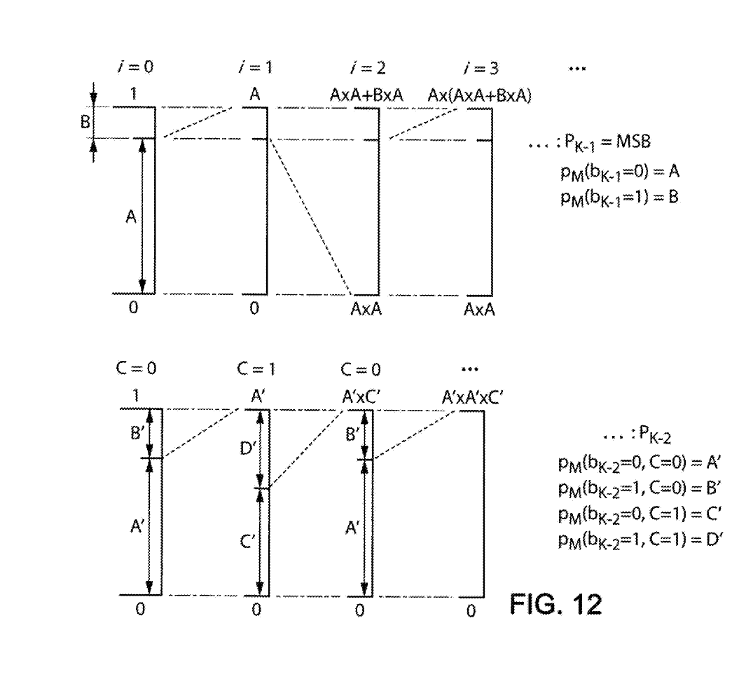

In a first embodiment, there is an estimation of the probability of having bits at 0 or 1 for each bit plane Pₖ, thus defining what was referred to above as the initial probability tables. These tables will be described below with reference to FIG. 12.

In a second embodiment, there is an estimation of conditional probabilities of 0 or 1 as a function of bits already encoded and in the same position in previous planes (these bits thus defining a context).

In a third embodiment, there is an estimation of conditional probabilities as a function of the number of possible context values limited to two (context “significant or not significant”).

One will remember that, in the state of the art, the initial probabilities of 0 and 1 in a plane Pₖ were set to the value ½=0.5, or, at best, previously saved in a table. However, in practice the probability of 0 and 1 in each plane can assume a value which can be quite different from ½ and more generally can be very different from one signal frame to the next, for example depending on the degree of voicing in the signal as will be seen below.

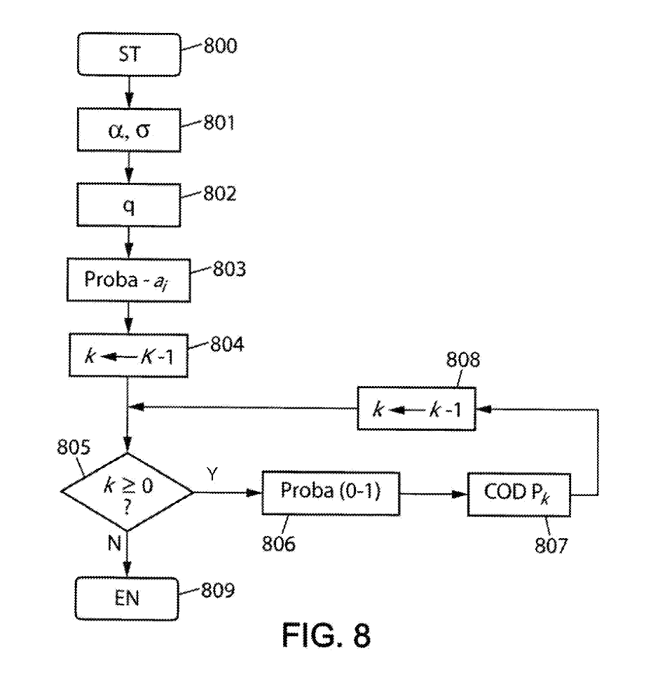

The flow chart in FIG. 8 shows the principle of bit plane encoding with, according to the first embodiment, an initialization of probability tables, for each plane Pₖ, which is based on a model. The parameters of the model which are the form factor α and the standard deviation σ are first estimated (step 801 after the starting step 800). Then the scalar quantization step size q is determined (step 802), for example from the value of the factor α as represented in FIG. 5. From the parameters σ, α, and q, the probabilities of the components aᵢ are estimated (step 802) as described above. Using a principle similar to that described with reference to FIG. 4, it is verified whether bit planes remain to be encoded by testing 805 the current value of a loop index k which is decremented (step 808) from K−1 to 0. Next the probabilities of having a bit at 0 or 1 in each plane is estimated (step 806), and then the encoding of this plane is done (step 807) using this information on the probabilities. This loop is repeated as long as the index k is positive or zero (as long as there are planes to encode). Otherwise the processing ends (end step 809) or can be restarted for a next signal block (or frame) to be encoded.

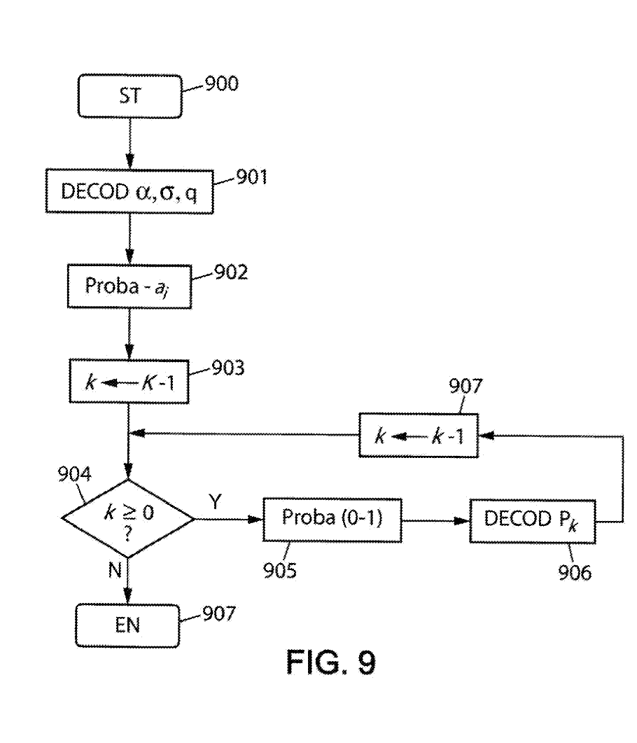

With reference now to FIG. 9, in the decoding, after a starting step 900, the parameters \hat{α}, \hat{σ}, and \hat{q} characterizing the distribution model which was used in the encoding are decoded (step 901). Then the probabilities associated with the components aᵢ are estimated, with this model (step 902). Next a loop is applied which decrements (step 907) the current loop index k initially set to K−1 (step 903). As long as the index k is positive (Y arrow exiting the test 904), the probabilities of 0 and 1 are estimated (step 906) in each plane Pₖ in order to decode each plane Pₖ more efficiently (step 907). Otherwise (k less than or equal to 0 corresponding to the N output from the test 904), no other plane is to be encoded and the processing can terminate (end step 908) or be restarted for a next block (or frame) to be decoded.

We saw above how the probabilities associated with the values of the components aᵢ are calculated. Now we will describe how the calculation of probabilities associated with a given symbol (step 806 in FIGS. 8 and 905 in FIG. 9) can result from this, for each plane Pₖ. For simplicity in the following equations, the probability p(aᵢ) associated with a component aᵢ is denoted by p(a) below.

The probability of obtaining the value 0 in a plane Pₖ can be calculated from the probability model again corresponding to a generalized Gaussian model in the example described. The probability of having the k^{th} bit, of the binary decomposition of a component aᵢ (therefore in the plane Pₖ), equal to zero, is given by:

$$p ( {B}_{k} ( {a}_{i} ) = 0 ) = p ( a ) \times {δ}_{{B}_{k} ( α ) , 0} where {δ}_{x , y} = \{ \begin{matrix}1 & if x = y \\ 0 & if x \neq y ,\end{matrix}$$

which is shortened below to p(Bₖ(aᵢ)=0) for convenience in writing the equations.

The relation which gives the probability of having the symbol 0 in the plane Pₖ is then:

$$p ( {b}_{k} = 0 \vert a \leq M ) = \frac{p ( {b}_{k} = 0 , a \leq M )}{p ( a \leq M )} ,$$

where bₖ and M are respectively:
a random variable representing any bit in the plane Pₖ, and
the integer with the largest absolute value that there can be in K planes, which is M=2^{K}−1.

From this we see that the expression of the probability is dependent on the total number of planes K and therefore on the number of integers than can be encoded. In fact, it is assumed here that the number of encoded planes is recorded in the bit stream and this data is therefore available in decoding as well as in encoding, particularly before the arithmetic encoding of the planes Pₖ. We therefore have a “conditional” probability: knowing that a≦M.

The probability p(a≦M) is defined by:

$$p ( a \leq M ) = {\sum }_{a = - M}^{M} p ( a ) .$$

The probability p(bₖ=0, a≦M) is defined

$$p ( {b}_{k} = 0 , a \leq M ) = {\sum }_{a = - M}^{M} p ( {B}_{k} ( a ) = 0 ) .$$

by:
To simplify writing the equations, the value p(bₖ=0|aᵢ≦M) (or p(bₖ=0|a≦M) is noted as follows: “p_{M}(bₖ=0)”.
One then obtains the following expression for the probability of having the value 0 in a plane Pₖ (step 806):

$${p}_{M} ( {b}_{k} = 0 ) = \frac{1}{{\sum }_{a = - M}^{M} p ( a )} \times {\sum }_{{a}_{i} = - M}^{M} p ( {B}_{k} ( a ) = 0 ) = \frac{1}{{\sum }_{a = - M}^{M} p ( a )} \times {\sum }_{{a}_{i} = - M}^{M} p ( a ) \times {δ}_{{B}_{k} ( a ) , 0}$$

From this we see that the probability p(aᵢ) (or p(a)) is involved in this last equation, which justifies its prior calculation in steps 803 and 902 of FIGS. 8 and 9.

The technique itself of bit plane encoding remains practically unchanged compared to the prior art. The essential difference lies, however, in the initialization of the probabilities of 0 to the value p(Bₖ(a)=0) given above, instead of choosing a default initialization value of ½ or a previously saved initialization value dependent on the bit rate or the source.

In order to obtain the probability of having the value 1, which is p_{M}(bₖ=1), one simply uses a complementary relation of the type: p_{M}(bₖ=1)+p_{M}(bₖ=0)=1.

FIG. 10 shows an example of different values (aᵢ=0, 1, 2, 3, . . . , 7) which can be taken from K=3 planes. Thus, for the plane P₂ (MSB), the bits with a zero value correspond to the integers 0, 1, 2 and 3 (solid line) and therefore the probability of having the 0 value in the MSB plane is, taking the last equation above, given by:

p_{M}(b₂=0)=p(aᵢ=0)+p(aᵢ=1)+p(aᵢ=2)+p(aᵢ=3)

Similarly, for the plane P₁, the bits with a zero value correspond to the integers 0, 1, 4 and 5 and:

p_{M}(b₁=0)=p(aᵢ=0)+p(aᵢ=1)+p(a₁=4)+p(aᵢ=5), and so on.

We will now explain, returning to FIG. 11, what the result of these probability calculations represents. In this figure, for purely illustrative purposes we have represented a spectral signal X which has the characteristic of being highly harmonic (or tonal). Thus the amplitude of the MDCT signal is large (its absolute value) in only a few consecutive frequencies (the significant bits have a value of 1 for these frequencies), while the amplitude associated with the other frequencies is relatively low (the significant bits retain a 0 value). As a result, the MSB plane and the plane or planes immediately following have few 1 bits. With the general shape of this signal, a small value of the form factor α (less than 0.5) can be found and the probability of obtaining values for 0 bits is high (close to 1) for the MSB plane and those which immediately follow it. However, the LSB plane of least significant bits and the planes immediately preceding it may contain, in a highly simplified explanation, as many 0s as 1s, depending on noise fluctuations, and the probability of finding bits with 0 values is then average (close to 0.5).

One should note that if the signal is less harmonic and with more noise (for example an unvoiced speech signal), the probability of finding bit values at 0 in the MSB plane will be lower (closer to 0.5). This observation is described in the Oger et al reference (FIG. 1 and its comments). Thus, if the signal of FIG. 11 is portrayed in the form of a histogram as described in this Oger et al reference, a narrow peak is obtained (denoted by H in FIG. 11), with a low value for the width at mid-height (giving the form factor α). However, for a very noisy signal or an unvoiced signal, the histogram would have a wider peak and a larger form factor α. One can understand here how the distribution model Mod of the source to be encoded (approximating the histogram H in FIG. 11) is related to the bit value probabilities at least in the first MSB plan.

These calculated probability values can then be given to an arithmetic encoder (or an arithmetic decoder), for example such as the one described in the Witten et al reference previously cited: “Arithmetic Coding for Data Compression”, I. H. Witten, R. M. Neal, J. G. Cleary, Communications of the ACM—Computing Practices, Vol. 30, No. 6 (June 1987), pp. 520-540. In this case, with reference to FIG. 12 (which can be compared to FIG. 1b (page 522) of this Witten et al document), the declarations p_{M}(b_{K-1}=0)=A and p_{M}(bₖ₋₁=1)=B define the probability tables of the plane P_{K-1}(MSB) (which can be compared to table I (page 521) of said Witten et al document).

By applying the present invention, it is thus possible to calculate, frame by frame, the probability tables p_{M}(b_{K-1}=0), p_{M}(b_{K-1}=1) for at least the MSB plane, directly from the form of the signal and without any need to save probability tables beforehand in the sense of the prior art, which requires additional memory resources in both the encoder and decoder and limits the flexibility of the implementation. In the sense of the invention, the probability calculations are performed directly on the signal, in real time, preferably by an initial estimation of the signal distribution model (module 507 in FIGS. 5 and 603 in FIG. 6) as described above.

Calculation of the values A=p_{M}(b_{K-1}=0) and B=p_{M}(b_{K-1}=1) corresponds to what has been referred to above as “probability table initialization”. This operation is preferably performed for each plane. In the first embodiment described above, these probabilities are calculated for a current plane Pₖ without taking into account bit values in planes other than Pₖ. In a second embodiment, these values are taken into account by defining a “context”.

In fact, again with reference to FIG. 11, one can see that in the planes which immediately follow the MSB plane, if a bit of a plane was at 1, the bit of the same rank in the plane immediately following is very often also 1. Of course, FIG. 11 is only presented as an illustration, but this observation can be made in actual cases. Typically, if a bit of a rank i is at 1 in a plane, it is then “most probable” that the bit of the same rank is also at 1 in a next plane. Conversely, it is usual that the amplitudes associated with several frequencies in a signal spectrum are near zero (particularly in the case of a speech signal). Therefore if the bit of a higher plane Pₖ is zero, it is “most probable” that a bit of the same rank in the next plane Pₖ₋₁ is also zero. As a result, to estimate the probability associated with a bit in a plane, one can advantageously take into account the value of the bit of the same rank in a previous plane. One can take advantage of this observation by defining, based on an observed value for a bit of rank i in a plane Pₖ (for example the only 1 bit in the MSB plane in FIG. 11), a context for a bit of the same rank i and in the following plane Pₖ₋₁ (bit also at 1 in this plane).

Use of this principle is made in particular by arithmetic encoders which are then called “context-based” encoders in the embodiments described below.

They apply a bit-plane encoding based on a model which allows conditional probability calculation for the planes Pₖ where k<K−1. The bit plane encoding described above does not make use of common information between planes Pₖ, because the planes Pₖ were encoded one by one and independently of each other. We now present a manner of making use of the information already encoded.

The MSB bit plane is encoded as in the previous case, independently of the other bit planes, initializing the probability of 0 and 1 based on the generalized Gaussian model. However, the encoding of the plane Pₖ where k<K−1 here uses the knowledge of “context” information about the previous planes P_{K-1}, . . . , Pₖ₊₂, Pₖ₊₁.

In general, probability tables are calculated for different possible contexts, therefore for different possible bit values taken from the previous planes.

For example, again with reference to FIG. 12, two probability tables are calculated for the plane P_{K-2} (each table so that a bit of the plane P_{K-2} is equal to 0 or 1) as a function of the possible bit values in the previous plane P_{K-1} (a table for a 0 value and a table for a 1 value), therefore as a function of the context denoted by C in FIG. 12. In the example represented, the value of the bit of rank i=0 in the plane P_{K-1} was 0, therefore the context is C=0 and the associated probability table is given by the values A′ and B′. For the rank i=1, the value of the corresponding bit in the plane P_{K-1} was 1, therefore the context is C=1 and the associated probability table is now given by the values C′ and D′. For the rank i=2, the value of the corresponding bit in the plane P_{K-1} was 0, therefore the context is C=0 and the probability table given by the values A′ and B′ is reused. Remember that the rank i designates the index i of a component aᵢ or y₁. One will note in FIG. 12 that the contexts C of the MSB plane are not defined (because, of course, there is not a more significant bit plane). To implement this embodiment on a computer, the contexts of the MSB plane are set as if all equal to 0.

We will not detail here how the planes are encoded, nor the manner in which the probability intervals are successively subdivided (although the limits of the intervals are indicated in FIG. 12). One can refer to the Witten et al document for the description of such elements.

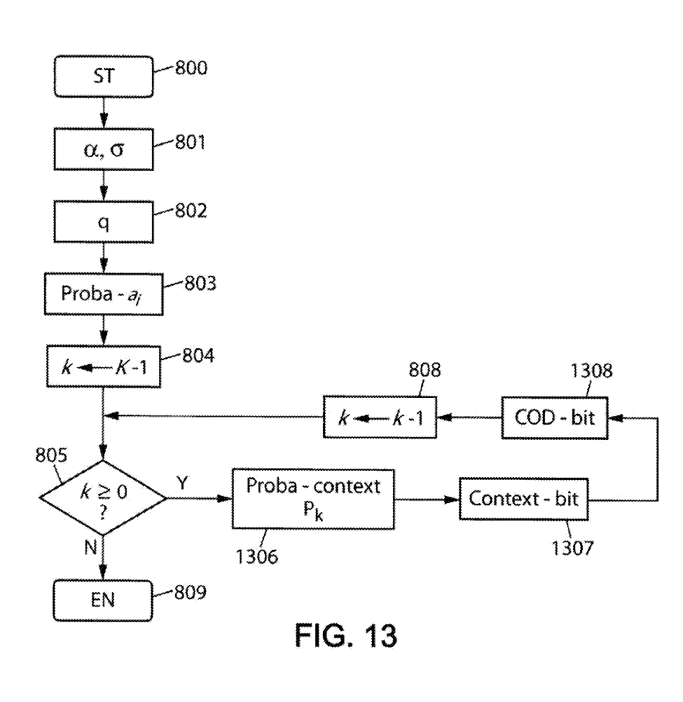

The flow chart in FIG. 13 shows the principle of bit plane encoding with context determination for each bit of a plane Pₖ, in a second embodiment of the invention. Elements similar to those of the flow chart in FIG. 8 are denoted by the same references and are not described again here.

If at least one plane is to be encoded (Y arrow exiting the test 805), the probabilities associated with the different possible context values for each plane are estimated (step 1306). In the second embodiment, the term “context” is understood to mean, for the i^{th} bit of the k^{th} plane, the set of bits of rank i in the planes preceding the plane Pₖ. Thus, with reference to FIG. 10, for the rank 7 in the plane P₁, the context is “1” (value of the bit of rank 7 in the plane P₂ (MSB)), while in the plane P₀, the context is “11” (1 being the value of the bit of rank 7 in the plane P₂ (MSB) and 1 being the value of the bit of rank 7 in the plane P₁).

With the context defined in this manner for a current bit, the probabilities are then estimated as a function of the context found (step 1307) for the rank of this bit. Then, with the probabilities calculated in this manner, each bit of a plane is encoded (step 1308l in FIG. 13) until all ranks are used. This processing is repeated for a next plane, again taking into account the context for each bit. This loop is repeated as long as there are planes to encode (Y arrow exiting the test 805). Otherwise (N arrow exiting the test 805), the encoding is terminated or can be implemented for a next signal block (or frame).

Thus at first the probability tables are calculated for various possible contexts, then, knowing the context, the probability of having the zero value or the 1 value is estimated for each bit. The manner of calculating the probability tables for different possible contexts is detailed below (the values A′, B′, C′, D′ in the example in FIG. 12).

The probability of the contexts themselves Cₖ(a) (step 1306) is calculated as follows. For the bit planes of lower rank than K−1 (other than the MSB plane), the contexts Cₖ(a) are defined as being the quotient of aᵢ by 2^{K-k} (in the plane Pₖ, which is:

$${C}_{k} ( a ) = {\sum }_{j = k + 1}^{K - 1} {B}_{j} ( a ) {2}^{j} , where - M \leq a < M and for all k < K .$$

For the plane Pₖ, the number of possible contexts is 2^{K-k}. The different possible values C_{k,n} values of contexts for the plane Pₖ are defined as follows:

$${c}_{k , n} = {\sum }_{j = k + 1}^{K - 1} {B}_{j} ( n ) {2}^{i}$$

$$where 0 \leq n < {2}^{K - k} and for all k < K .$$

Thus, in the second embodiment, with reference to the example in FIG. 10 where K=3 planes, in the plane k=1, we count four different contexts which are {00,01,10,11} and the probability of having the k^{th} context of a in the plane Pₖ equal to C_{k,n} is given (in the step 1306 of FIG. 13) by:

$$\begin{matrix}p ( {C}_{k} ( a ) = {c}_{k , n} ) = p ( {B}_{k + 1} ( a ) = {B}_{k + 1} ( n ) ) \times p ( {C}_{k + 1} ( a ) = {c}_{k , n} ) \\ = {\prod }_{j = k + 1}^{K - 1} p ( {B}_{i} ( a ) = {B}_{j} ( n ) ) \\ = p ( a ) \times {\prod }_{j = k + 1}^{K - 1} {δ}_{{B}_{i} ( a ) , {B}_{j} ( n )}\end{matrix}$$

Now, knowing the context Cₖ(a), the conditional probability of having the zero value for k<K−1 is calculated, in the step 1307 of FIG. 13, as follows.

One attempts to make use of the initial knowledge of the context (planes of rank k+1 to K−1) during encoding of the plane Pₖ. The conditional probability of having the value 0, knowing the context c_{k,n} for k<K−1, is defined by:

$${p}_{M} ( {b}_{k} = 0 \vert {c}_{k} = {c}_{k , n} ) = \frac{{p}_{M} ( {b}_{k} = 0 , {c}_{k} = {c}_{k , n} )}{{p}_{M} ( {c}_{k} = {c}_{k , n} )}$$

The following relations allow determining all the probabilities at issue for the 2^{K-k} different possible context values (0, 1, 00, 01, 10, 11, 000, etc.):

$$\{ \begin{matrix} {p}_{M} ( {b}_{k} = 0 \vert {c}_{k} = {c}_{k , n} ) + {p}_{M} ( {b}_{k} = 1 \vert {c}_{k} = {c}_{k , n} ) = 1 \\ {\sum }_{n = 0}^{{E}^{K - 1}} {p}_{M} ( {c}_{k} = {c}_{k , n} ) = 1\end{matrix}$$

The probability p_{M}(cₖ=c_{k,n}), for k<K−1, is defined by the relation:

$$\begin{matrix}{p}_{M} ( {c}_{k} = {c}_{k , n} ) = \frac{1}{{\sum }_{a = - M}^{M} p ( a )} \times [ {\sum }_{a = - M}^{M} p ( {C}_{k} ( a ) = {c}_{k , n} ) ] \\ = \frac{1}{{\sum }_{a = - M}^{M} p ( a )} \times {\sum }_{a = - M}^{M} [ p ( a ) \times {\prod }_{j = k + 1}^{K - 1} {δ}_{{B}_{i} ( a ) , {B}_{j} ( n )}\end{matrix}$$

As for the probability p_{M}(bₖ=0, cₖ=c_{k,n}), for k<K−1, this is defined by the relation

$$\begin{matrix}{p}_{M} ( {b}_{k} = 0 , {c}_{k} = {c}_{k , n} ) = \frac{1}{{\sum }_{a = - M}^{M} p ( a )} \times {\sum }_{{a}_{i} = - M}^{M} [ p ( {B}_{k} ( a ) = 0 ) \times p ( {C}_{k} ( a ) = {c}_{k , n} ) ] \\ = \frac{1}{{\sum }_{a = - M}^{M} p ( a )} \times {\sum }_{a = - M}^{M} [ p ( a ) \times {δ}_{{B}_{k} ( a ) , 0} \times {\prod }_{j = k + 1}^{K - 1} {δ}_{{B}_{i} ( a ) , {B}_{j} ( n )} ]\end{matrix}$$

Thus, the conditional probability of having the value 0 knowing the context c_{k,n} (step 1307), denoted by p_{M}(bₖ=0 I cₖ=c_{k,n}), for k<K−1, is finally defined by the relation:

$${p}_{M} ( {b}_{k} = 0 \vert {c}_{k} = {c}_{k , n} ) = \frac{{\sum }_{a = - M}^{M} [ p ( a ) \times {δ}_{{B}_{k} ( a ) , 0} \times {\prod }_{j = k + 1}^{K - 1} {δ}_{{B}_{i} ( a ) , {B}_{j} ( n )} ]}{{\sum }_{a = - M}^{M} [ p ( a ) \times {\prod }_{j = k + 1}^{K - 1} {δ}_{{B}_{i} ( a ) , {B}_{j} ( n )} ]}$$

An example of calculating the conditional probability for k<K−1 is again presented in FIG. 10, in which it is decided that all the contexts are zero for the plane P₂ (MSB). For the plane P₁ two possible 0 or 1 contexts are counted, while for the plane P₀ (LSB), four possible contexts are counted which are {00, 01, 10, 11} and for the plane P₀, the integers whose context is “00” are 0 and 1. The probability of having the “00” context (dotted lines in FIG. 10) is therefore given by:)

p_{M}(c₀=00)=p(aᵢ=0)+p(aᵢ=1)

In the case where the context is “00”, the only integer whose bit in the plane P₀ has the binary value 0 is the integer 0. Thus, the probability of having a bit equal to zero in the plane P₀, knowing that the context is “00”, is given by:

$${p}_{M} ( {b}_{0} = 0 \vert {c}_{0} = 00 ) = \frac{p ( {a}_{i} = 0 )}{p ( {a}_{i} = 0 ) + p ( {a}_{i} = 1 )}$$

Conversely, the probability of having a bit equal to 1 in the plane P₀, knowing that the context is “00”, is given by:

$${p}_{M} ( {b}_{0} = 1 \vert {c}_{0} = 00 ) = 1 - {p}_{M} ( {b}_{0} = 0 \vert {c}_{0} = 00 ) = 1 - \frac{p ( {a}_{i} = 0 )}{p ( {a}_{i} = 0 ) + p ( {a}_{i} = 1 )}$$

One will observe that the calculation of probability tables for the last planes (including the LSB plane with 2^{K} possible contexts) is tedious because of the exponential growth in the number of contexts to be considered. We will now describe the third embodiment, corresponding to a context-based arithmetic encoding by bit planes based on a model, with calculation of the conditional probability for k<K−1, in particular in the case where a limited number of possible contexts is imposed (two possible contexts here). This is a variation of the previous case corresponding to a conditional probability with use of contexts, in which, instead of having a number of contacts which increases by a factor of 2 at each new plane as one travels from the MSB plane to the LSB plane, instead a maximum number of contexts associated with a single bit (0 or 1) is fixed.

In the example described, this maximum number is two and is interpreted as follows:
a context at 0 indicates that the bits encoded in the higher planes and at the same rank are all equal to 0 and therefore that the MDCT quantized coefficient, for this rank, is for the time being not significant, and
a context at 1 indicates that at least one of the bits already encoded in the higher planes and at the same rank was equal to 1, which implies that the current coefficient, for this rank, is significant.

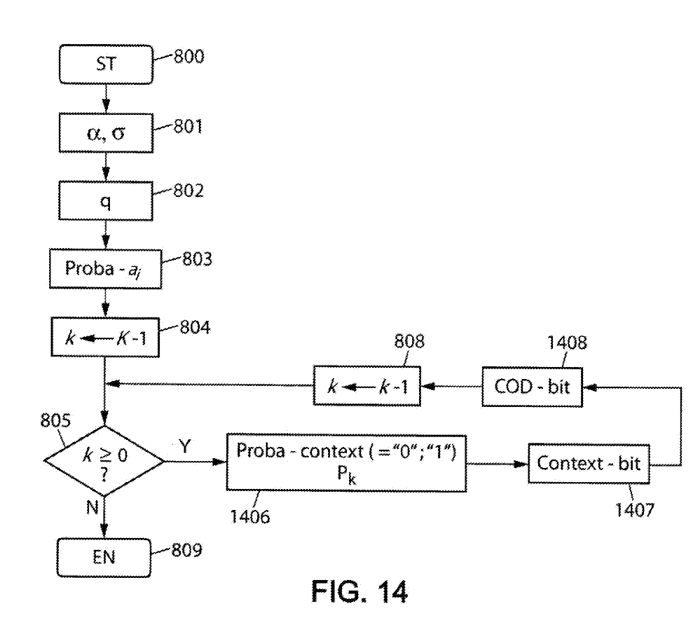

The flow chart in FIG. 14 shows this principle of bit plane encoding with context determination for each bit of a plane Pₖ, limiting the number of possible contexts to two (“0” or “1” in the step 1406). The elements similar to those in the flow charts in FIGS. 8 and 13 are denoted by the same references and are not described again here. Only the steps 1406, 1407, and 1408 are modified in the sense that the only possible values of the context are now 0 or 1, which also influences the encoding done (step 1408).

Below is an example of calculating the conditional probability, for k<K−1, done in step 1406 of FIG. 14 with these two possible context values. With reference to FIG. 10, this example where the two possible contexts are 0 and 1 is reused. In the plane P₁, the bits whose context is “0” (which corresponds to having the value 0 for all planes before the current plane, therefore for P₂ corresponding to the MSB plane) are those of the integers aᵢ=0, 1, 2, and 3. The probability of having a context equal to zero is therefore given by:

p_{M}(c₁=0)=p(aᵢ=0)+p(aᵢ=1)+p(aᵢ=2)+p(aᵢ=3)

In the plane P₀ (LSB), the bits whose context is “0” (referring to the planes P₁ and P₂) are those of the integers aᵢ=0 and 1. The probability of having a context equal to zero is then

p_{M}(c₀=0)=p(aᵢ=0)+p(aᵢ=1).

The probability of having the context equal to 0 is calculated as follows (step 1406 in FIG. 14). Contexts are defined for the planes Pₖ with k<K−1 (other than the MSB plane):

$${c}_{k} ( a ) = \{ \begin{matrix}1 & if there exists {B}_{j} ( a ) = 1 for j = k + 1 , … K - 1 \\ 0 & otherwise\end{matrix}$$

The probability of having the k^{th} context of a in the plane Pₖ equal to zero is then given (step 1406) by a recursive relation of the form:

$$\begin{matrix}p ( {C}_{k} ( a ) = 0 ) = p ( {B}_{k + 1} ( a ) = 0 ) \times p ( {C}_{k + 1} ( a ) = 0 ) \\ = {\prod }_{j = k + 1}^{K - 1} p ( {B}_{j} ( a ) = 0 ) \\ = p ( a ) \times {\prod }_{j = k + 1}^{K - 1} {δ}_{{B}_{j} ( a ) , 0}\end{matrix}$$

The calculation of the conditional probability of having the zero value, for k<K−1, with two choices of possible contexts (in step 1407 of FIG. 14) is made by making use of the knowledge of the context (presence of a bit equal to 1 in the planes of rank k+1 to K−1) during encoding of the plane of rank Pₖ. The conditional probability for k<K−1 (step 1407) is then defined as follows:

$${p}_{M} ( {b}_{k} = 0 \vert {c}_{k} = 0 ) = \frac{{p}_{M} ( {b}_{k} = 0 , {c}_{k} = 0 )}{{p}_{M} ( {c}_{k} = 0 )}$$

where cₖ is a random variable representing the context associated with any bit bₖ in the plane Pₖ.

The probability p_{M}(cₖ=0), for k<K−1, is given by the relation:

$$\begin{matrix}{p}_{M} ( {c}_{k} = 0 ) = \frac{1}{{\sum }_{{a}_{i} = - M}^{M} p ( a )} \times {\sum }_{{a}_{i} = - M}^{M} p ( {C}_{k} ( a ) = 0 ) \\ = \frac{1}{{\sum }_{a = - M}^{M} p ( a )} \times {\sum }_{a = - M}^{M} [ {\prod }_{j = k + 1}^{K - 1} p ( {B}_{j} ( a ) = 0 ) ] \\ = \frac{1}{{\sum }_{a = - M}^{M} p ( a )} \times {\sum }_{a = - M}^{M} [ p ( a ) \times {\prod }_{j = k + 1}^{K - 1} {δ}_{{B}_{i} ( a ) , 0} ]\end{matrix}$$

As for the probability p(bₖ=0,cₖ=0), for k<K−1, it is defined by the relation:

$$\begin{matrix}{p}_{M} ( {b}_{k} = 0 , {c}_{k} = 0 ) = \frac{1}{{\sum }_{a = - M}^{M} p ( a )} \times {\sum }_{{a}_{i} = - M}^{M} [ p ( {B}_{k} ( a ) = 0 ) \times p ( {C}_{k} ( a ) = 0 ) ] \\ = \frac{1}{{\sum }_{a = - M}^{M} p ( a )} \times {\sum }_{a = - M}^{M} [ p ( a ) \times {\prod }_{j = k}^{K - 1} {δ}_{{B}_{i} ( a ) , 0} ]\end{matrix}$$

The conditional probability for k<K−1 is therefore defined by:

$${p}_{M} ( {b}_{k} = 0 \vert {c}_{k} = 0 ) = \frac{{\sum }_{a = - M}^{M} [ p ( a ) \times {\prod }_{j = k}^{K - 1} {δ}_{{B}_{i} ( a ) , 0} ]}{{\sum }_{a = - M}^{M} [ p ( a ) \times {\prod }_{j = k + 1}^{K - 1} {δ}_{{B}_{i} ( a ) , 0} ]}$$

It is also possible to calculate p_{M}(bₖ=0|cₖ=1) in a similar manner.

The invention, according to any one of the above three embodiments, then results in an effective technique of bit plane encoding and renders this type of encoding more flexible than in the prior art. In fact, it becomes possible to no longer store pre-calculated probability tables (contexts). A dynamic calculation, based simply on the signal to be encoded/decoded, is then sufficient.

The invention also concerns an encoder for implementing the method of the invention, such as the exemplary one represented in FIG. 5 and described above, and then comprising a module 505 for estimating a distribution of the signal to be encoded, supplying data to a module 507 for calculating probabilities of symbol values. It also concerns a decoder for the implementation of the method of the invention, such as the exemplary one represented in FIG. 6 and described above, and then comprising a module 603 for calculating probabilities of symbol values, based on an estimate of a signal distribution. In particular, this module 603 is supplied at least one parameter (for example the form factor α) characterizing the probability density model of the signal before encoding, with this parameter a being received by the decoder in encoded form and then decoded (denoted by in FIG. 6).

The invention also concerns a computer program intended to be stored in a memory of such an encoder or such a decoder. The program comprises instructions for implementing the method of the invention, when it is executed by a processor of the encoder or decoder. For example, the flowcharts in FIG. 8, 9, 13 or 14 can represent respective algorithms for different versions of such a computer program.

Of course, the invention is not limited to the embodiments described here; it extends to other variations.

For example, in practice the arithmetic encoders do not work directly with symbol probabilities, but rather with the entire frequencies of symbols. The invention described above easily adapts to the use of frequencies, because frequencies correspond to the probability multiplied by a number of observed occurrences. One can again refer to the Witten et al document for more details on this point. It is therefore sufficient to convert the probabilities estimated as above into frequencies.

Even more generally, symbol planes were described above whose values were the bit values “0” or “1”. The invention extends, however, to an application of symbol plane encoding/decoding (with more than two symbols, for example three symbols: “0”, “+1”, “−1”). The Witten et al reference (table I and FIG. 1b) indicates how to manage the probabilities associated with more than two symbols. Thus the invention allows evaluating the probability of symbols in at least one symbol plane (preferably the most significant symbol plane), based on a model of the source (signal to be encoded/decoded).

The principle of the invention could also be applied to the case of stack-run encoding where the probabilities of four symbols (0,1,+,−) for stacks and runs are calculated from a distribution model of the signal to be encoded (as described in the Oger et al reference given above), for example from a generalized Gaussian model. In this case, one can initialize the probabilities of the symbols 0, 1, +, and −, based on the value of the parameter a associated with the model.

Also, as was discussed above, the invention allows optimizing the contexts of context-based arithmetic encoding. Aside from the fact that the encoding in the sense of the invention can be context-based arithmetic encoding, it can also be adaptive (for example as a function of the bit rate, the source, or the values taken by bits in the same plane) as described for example in the Langdon et al reference cited above.

Even more generally, the invention applies to any type of encoding (Huffman or other) based on the probabilities of symbols in symbol plane encoding. Thus, the invention can apply more generally to other types of entropy encoding besides arithmetic encoding.

The case of the generalized Gaussian model with transmission of the form parameter was only described above as an example of an embodiment. Models other than the generalized Gaussian model are possible. For example, models with probabilities that are fixed (a Laplacian model in particular) or parametric (alpha-stable, mixed-Gaussian, or other models) can also be considered for modeling the source.

Even more generally, it is possible not to model the signal distribution, but simply to calculate the probability tables in encoding on the basis of the raw (not modeled) signal distribution. One can then encode these probability tables and send them to the decoder such that the decoder does not have to recalculate them (elimination of the module 603 in FIG. 6 and receipt of probability tables instead of the form factor α). Even so, it is preferred to model the signal distribution and only send the decoder a few parameters (notably the form factor α) which characterize the model, as described above, in order to limit the amount of data in the encoded bit stream.

1. A method for processing a signal for a symbol plane compression encoding or decoding in compression of the signal, wherein probabilities of symbol values are determined for at least one plane (P_{K-1}), said probabilities being calculated dynamically, from an estimation (Mod) of a distribution of the signal (X).

2. The method according to claim 1, wherein the signal is quantized before encoding, the estimation of the signal distribution being performed on the signal to be encoded (X), preferably before quantization.

3. The method according to claim 1, wherein the estimation of the signal distribution comprises modeling [[of]] the signal distribution (H), in order to deduce at least one parameter (α) characterizing a model (Mod) representing a probability density (pdf) of the signal.

4. The method according to claim 3, wherein:
the modeling is performed in the encoding,
said parameter (α) is communicated for the purposes of decoding, and
said probabilities are calculated, in the encoding and in the decoding, as a function of said parameter (α).

5. A process The method according to claim 3, wherein the model is a generalized Gaussian model, and wherein said parameter is a form factor (α).

6. The method according to claim 1, wherein, the signal comprises a succession of values (aᵢ), each value (aᵢ) is decomposed into a plurality of symbol values (0;1) in a respective plurality of symbol planes (Pₖ), with said probabilities being calculated for at least one plane (MSB) and each indicating the probability of having, in this plane, a symbol value equal to a given symbol, said probabilities being calculated at least for the plane (MSB) representing the most significant symbol values.

7. The method according to claim 6, wherein said probabilities are further calculated for other planes (Pₖ), taking into account a context (C) defined by symbol values taken from planes (Pₖ₊₁, Pₖ₊₂, . . . , P_{K-1}) representing more significant symbol values.

8. The method according to claim 7, wherein, for a same position (i) of a signal value (aᵢ) in said succession of values, each symbol value taken from a plane (Pₖ₊₁, Pₖ₊₂, . . . , P_{K-1}) representing a more significant value than a symbol value in a current plane (Pₖ), defines a context value (C) for this current plane (Pₖ) and for this position (i), and
wherein said probabilities are calculated for the current plane (Pₖ) while taking into account a plurality of possible values of the context (C) for the current plane (Pₖ).

9. The method according to claim 8, wherein a limited number of possible values of the context (C) are chosen.

10. The method according to claim 9, wherein the possible context values per symbol plane are limited to the two following context values:
a first context value indicating the occurrence of at least one significant symbol value in the planes (Pₖ₊₁, Pₖ₊₂, . . . , P_{K-1}) representing more significant symbol values,
a second context value signifying that no occurrence of a significant symbol value was found in the planes (Pₖ₊₁, Pₖ₊₂, . . . P_{K-1}) representing more significant symbol values.

11. An encoder for implementing the method according to claim 1, wherein it comprises a module for estimating a distribution of the signal to be encoded, supplying data to a module for calculating said probabilities of symbol values.

12. A decoder for implementing the method according to claim 1, wherein it comprises a module for calculating said probabilities of symbol values, based on an estimation (α) of a distribution of the signal.

13. A decoder for implementing the process method according to claim 4, wherein it comprises a module for calculating said probabilities of symbol values, based on an estimation (α) of a distribution of the signal, said module being supplied with at least one parameter (α) characterizing the probability density model of the signal before encoding, with said parameter being received by the decoder.

14. A computer program intended to be stored in a memory of an encoder or a decoder, wherein it comprises instructions for the implementation of the method according to claim 1 when it is executed by a processor of the encoder or decoder.
